(19) United States
(12) Patent Application Publication
(10) Pub. No.: US 2009/0096812 A1
(43) Pub. Date: Apr. 16, 2009

(54) APPARATUS AND METHOD FOR MORPHING DATA VISUALIZATIONS

(75) Inventors: Rodolphe BOIXEL, Courbevoie (FR); Nicolas MOUREY, Fleury-en-Biere (FR)

Correspondence Address: SAP Global c/o Cooley Godward Kronish LLP;William S. Galliani, 777 6th Street NW, Suite 1100, Washington, DC, 20001, US

(73) Assignee: BUSINESS OBJECTS, S.A., Levallois-Perret (FR)

(21) Appl. No.: 11/871,952

(22) Filed: Oct. 12, 2007

(51) Int. Cl. G09G 5/00

(52) U.S. Cl. 345/646; 345/440

(57) ABSTRACT

A computer readable storage medium comprises executable instructions to display a first visualization associated with a first set of data. A display transformation from the first visualization into a second visualization is animated by morphing selected polygons in the first visualization into corresponding polygons in the second visualization while fading the first visualization into the second visualization.

### BRIEF DESCRIPTION OF THE INVENTION

This invention relates generally to data visualizations. More particularly, this invention relates to morphing techniques for maintaining focus on selected regions when transitioning between two data visualizations.

### BACKGROUND OF THE INVENTION

Business Intelligence generally refers to a category of software systems and applications used to improve business enterprise decision-making and governance. These software tools provide techniques for analyzing and leveraging enterprise applications and data. They are commonly applied to financial, human resource, marketing, sales, service provision, customer, and supplier analyses. More specifically, Business Intelligence tools can include reporting and analysis tools to analyze, forecast and present information, content delivery infrastructure systems to deliver, store and manage reports and analytics, data warehousing systems to cleanse and consolidate information from disparate sources, integration tools to analyze and generate workflows based on enterprise systems, database management systems to organize, store, retrieve and manage data in databases, and performance management applications to provide business metrics, dashboards, and scorecards, as well as best-practice analysis techniques for gaining business insights.

In many organizations establishing business strategies is an increasingly complex exercise. There are ongoing efforts to supply quantitative tools to enhance business strategy decision making. In particular, there is an increasing focus on applications and tools that provide a quantitative framework for analyzing various measures. A measure is a quantity as ascertained by comparison with a standard, usually denoted in units such as units sold, dollars, and so on. Measures are typically used to evaluate a quantifiable component of an organization's performance. For example, measures may include return on investment, revenues, sales volume, unit sales, store sales, inventory levels, cycle times, supply chain costs, number of customers, and so on.

Measures may be associated with dimensions, which are a type of data model object that represent a side of a multidimensional cube, a category, a column or a set of data items within a data source. Each dimension represents a different category. Dimension definitions support the specification of hierarchies to form a Hierarchical Dimension. Members of a dimension may be defined through a filter or transform. Examples of dimensions include region, store, year, customer, employee, and product line, among others.

Measures are often analyzed as part of visualizations, which are graphic displays of quantitative information. Types of visualizations include charts, tables, and maps. These visualizations can be included in a report document and reveal insights into the relationships between data. In tables, where data is displayed in columns and rows, such insights can be inefficient, difficult, or even impossible, to obtain. While tables are limited in variety there are many types of charts and maps, such as line charts, bar charts, pie charts, and geographical maps, among others.

For example, consider a retail organization trying to optimize its performance. A store manager may be interested in increasing its profits for the current quarter. To perform a detailed assessment, the store manager may have to analyze a large amount of data, such as, for example, “store costs” and “revenue” measures during the previous quarters. The store manager may also have to compare the “revenue” measure for a given store with the “revenue” measure of other comparable stores in the retail organization.

Visualizations of the measures may be performed to facilitate the store manager's analysis. For example, the average “store costs” measure may be plotted in a line chart to understand how the costs have been changing over the previous years, the average “revenue” measure for all stores may be plotted in a pie chart to evaluate which stores are outperforming the others, and a geographical map may be used to analyze the “revenue” measure for each geographical region. These are just some of the sample visualizations that the manager may use to better navigate the data to be analyzed. Other visualizations may be performed, with data originating from one or multiple datasets.

There are a number of commercially available tools for visualizing data. For example, Business Objects Americas of San Jose, Calif., sells a number of widely used Business Intelligence and performance management tools that provide data visualizations, including Crystal Xcelsius™, BusinessObjects Performance Manager™, BusinessObjects Enterpise™, BusinessObjects XI™, and BusinessObjects Dashboard Builder™, to name a few. These tools include various frameworks for visualizing data, such as performance dashboards and scorecards.

These and other BI tools that provide data visualizations allow users to see their data in multiple forms, such as line charts, tables, bar charts, geographical maps, etc., sometimes simultaneously in a single display screen. Because the visualizations are tied to the data set they represent, as soon as the data set changes the visualization changes. Changes in a data set may cause minor changes to the visualization, e.g., with the addition or removal of data, or result in a completely different visualization with potentially completely different data. For example, a bar chart may be displaying product sales for a given region over a given time period. Adding a country to the region displayed or displaying data for another region will change the display of the bar chart.

The currently-available BI tools are limited with regards to the data visualization capabilities they offer. In particular, these tools do not allow users to visualize transformations for a given data set. Any time a data set selection changes to produce a different visualization or any time a user desires to visualize a different data set, the user is not able to follow the trajectory of a given portion of the data from one visualization to the next. Doing so often requires that the user search the new visualization to find the desired data. That is, the user is not able to focus on a selected portion of the data to seamlessly understand how the data is transformed between visualizations.

Accordingly, it would be desirable to provide techniques to address the shortcomings of existing visualizations provided by BI tools. In particular, it would be desirable to provide techniques to enable users to focus on selected portions of a data set to seamlessly understand how the selected data is transformed between visualizations.

### SUMMARY OF THE INVENTION

The invention includes a computer readable medium with executable instructions to display a first visualization associated with a first set of data. A display transformation from the first visualization into a second visualization is animated by morphing selected polygons in the first visualization into corresponding polygons in the second visualization while fading the first visualization into the second visualization.

The invention also includes a computer readable medium with executable instructions to retrieve a first set of data associated with a first visualization and a second set of data associated with a second visualization, the first visualization displayed on a display screen and the second visualization selected for display by a user on the display screen after the first visualization. A first set of polygons representing the first set of data is identified. A second set of polygons representing the second set of data is matched with the first set of polygons representing the first set of data. The first visualization is faded out of the display screen. The first set of polygons is morphed into the second set of polygons. The second visualization is faded into the display screen.

The invention further includes a method for morphing a first visualization into a second visualization. A first set of polygons representing a first set of data corresponding to the first visualization is identified. A second set of polygons representing a second set of data corresponding to the second visualization is also identified. Points in the first set of polygons are matched with points in the second set of polygons. The first visualization is faded out. A set of intermediate polygons is displayed while morphing the points in the first set of polygons into matching points in the second set of polygons. The second visualization is then faded in.

### BRIEF DESCRIPTION OF THE DRAWINGS

The invention is more fully appreciated in connection with the following detailed description taken in conjunction with the accompanying drawings, in which like reference characters refer to like parts throughout, and in which:

FIG. 1 illustrates a computer constructed in accordance with an embodiment of the invention;

FIG. 2 illustrates a flow chart for morphing data visualizations in accordance with an embodiment of the invention;

FIGS. 3(a)-(e) illustrate a series of visualizations showing an exemplary region of a data set being morphed from one visualization to the next in accordance with an embodiment of the invention;

FIG. 4 illustrates an exemplary bar chart in accordance with an embodiment of the invention;

FIG. 5 illustrates an intermediate visualization produced when morphing a region of the bar chart of FIG. 4 to generate a tree visualization in accordance with an embodiment of the invention;

FIG. 6 illustrates an exemplary tree visualization generated after the morphing of FIG. 5 in accordance with an embodiment of the invention;

FIG. 7 illustrates an intermediate visualization produced when morphing a region of the tree visualization of FIG. 6 to generate a pie chart in accordance with an embodiment of the invention;

FIG. 8 illustrates an exemplary pie chart generated after the morphing of FIG. 7 in accordance with an embodiment of the invention;

FIG. 9 illustrates an intermediate visualization produced when morphing a region of the pie chart of FIG. 8 to generate a line chart in accordance with an embodiment of the invention;

FIG. 10 illustrates an exemplary line chart generated after the morphing of FIG. 9 in accordance with an embodiment of the invention;

FIG. 11 illustrates an exemplary bar chart in accordance with an embodiment of the invention;

FIG. 12 illustrates another version of the exemplary bar chart of FIG. 11 in accordance with an embodiment of the invention;

FIG. 13 illustrates another exemplary bar chart in accordance with an embodiment of the invention;

FIG. 14 illustrates an intermediate visualization produced when morphing a region of the bar chart of FIG. 13 to generate another bar chart in accordance with an embodiment of the invention; and

FIG. 15 illustrates a bar chart generated after the morphing of FIG. 14 in accordance with an embodiment of the invention.

### DETAILED DESCRIPTION OF THE INVENTION

The present invention provides a system, method, software arrangement, and computer readable storage medium for morphing data visualizations. As generally used herein, morphing refers to a transition state from one visualization to another. A visualization, as generally used herein, is a graphic display of quantitative information. Types of visualizations include charts, tables, and maps.

A chart includes a collection of visual elements used to convey information. Data is converted to a pictorial representation such as a line, representative area, color, and the like. Often a chart is of a well known chart type that makes comparison between charts easier. Charts can be grouped into families. Families of charts include, but are not limited to: status charts (e.g., gauges, barometers/thermometers, LEDs); variation charts (e.g., radar, polar, heat maps); contribution comparison charts (e.g., pie, stacked 100%, pie series); rank compare charts (e.g., horizontal, grouped bar, deviation/zero axis bar, floating, stacked/subdivided); time series charts (e.g., line graph, column, waterfall/floating, deviated/zero axis, stacked/subdivided bar, stock/open-high-low-close, times series line, times series surface); frequency distribution charts (e.g., histogram, histograph); correlation charts (e.g., scatter plot, bubble plot, paired bar chart, paired/multiple scatter plot, bubble chart); combination charts (e.g., bar chart with line, pie slice with stacked bar, pie in time series, table); and other charts (e.g., graphical lists, spie chart, chart, log plot, semi-log plot, stereogram, contour plot, hanging rootogram, box plot, bag plot, mesh plot, contour plot, graph, network, and tree).

A table displays a set of data in a series of columns or rows. The table can have row and column headings, where each cell in a table can show the value associated with the specific combination of row and column headings. Some tables can hold charts or maps in their cells; this is a spatially economic way to display many charts with common axes. To facilitate representation in two dimensions, higher-dimensional tables of data are often represented using a plurality of two-dimensional tables.

A map is a simplified depiction of a space that highlights relations between elements in the space. Typically, a map is a two-dimensional, geometrically accurate representation of a space. A map is not limited to a two-dimensional cartographic map. A map can be augmented to include extra information presented in the form of an added dimension, e.g., height, color, density. A map can include other visualizations in regions of the map, e.g., a map with pie charts in each region.

According to an embodiment of the invention, a user may select a region in a first visualization for morphing into a region in a second visualization. The region may be, for example, a country or other geographical region in a geographical map, one or more bars in a bar chart, one or more slices in a pie chart, or one or more regions in a line chart, among others. The morphing occurs by first highlighting or drawing attention to the region in the first visualization. The first visualization is then faded out from the display screen to give way for the second visualization to be displayed. Before the second visualization is displayed, the highlighted region in the first visualization is morphed until it reaches its corresponding shape in the second visualization. Once morphing is completed, the second visualization is faded into the display screen.

According to an embodiment of the invention, a region in a first visualization may be represented by one or more polygons, which are geometric shapes bounded by a closed path. Intermediate polygons are created and displayed in the display screen during morphing, with each consecutive set of polygons forming a shape closer to the shape of the region in the second visualization. For example, to morph a bar in a bar chart into a pie slice in a pie chart, a rectangle representing the bar (with its size, position, and color) is morphed into a pie slice (with its size, position, and potentially a new color).

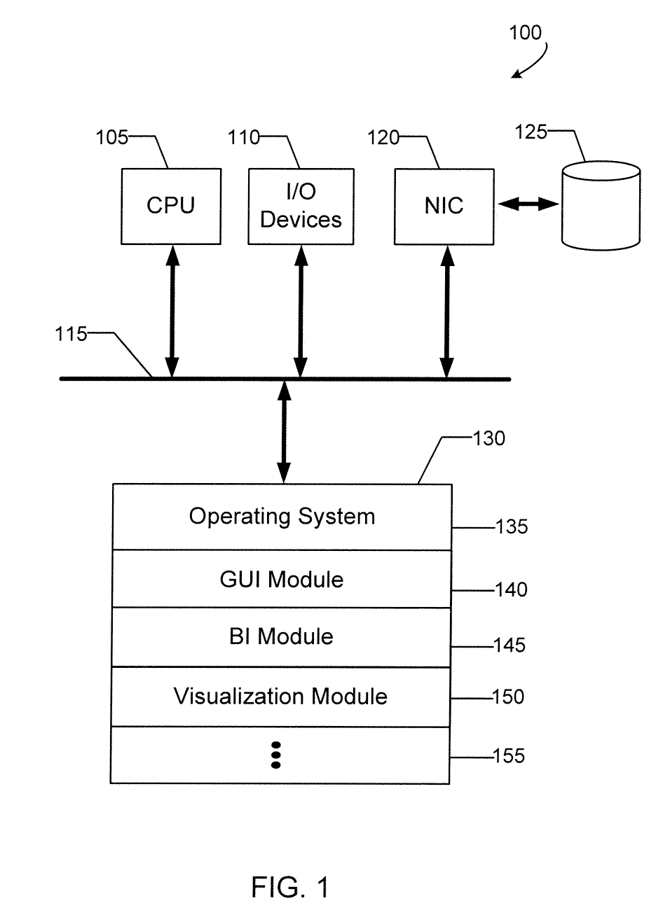

FIG. 1 illustrates a computer configured in accordance with an embodiment of the invention. Computer 100 includes standard components, including a Central Processing Unit (“CPU”) 105 and input/output devices 110, which are linked by a bus 115. Input/output devices 110 may include a keyboard, mouse, touch screen, monitor, printer, and the like.

Network Interface Circuit (“NIC”) 120 may also be connected to the bus 115. NIC 120 provides connectivity to a network (not shown), thereby allowing computer 100 to operate in a networked environment. For example, networked data sources 125 are connected to computer 100 through NIC 120. In accordance with the present invention, networked data sources 125 may include any number and type of data sources.

It is appreciated that a data source is an information resource. Data sources such as networked data sources 125 include sources of data that enable data storage and retrieval. Networked data sources 125 may include databases, such as, relational, transactional, hierarchical, multidimensional (e.g., Online Analytical Processing (“OLAP”)), object oriented databases, and the like. Further networked data sources 125 may include tabular data (e.g., spreadsheets, delimited text files), data tagged with a markup language (e.g., Extensible Markup Language (“XML”) data), transactional data, unstructured data (e.g., text files, screen scrapings), hierarchical data (e.g., data in a file system, XML data), files, a plurality of reports, and any other data source accessible through an established protocol, such as, Open DataBase Connectivity (“ODBC”) and the like. Networked data sources 125 may also include a data source where the data is not stored like data streams, broadcast data, and the like.

Memory 130 is also connected to the bus 115. In one exemplary embodiment, memory 130 stores one or more of the following modules: an operating system module 135, a Graphical User Interface (“GUI”) module 140, a Business Intelligence (“BI”) module 145, and a Visualization module 150.

Operating system module 135 may include instructions for handling various system services, such as file services or for performing hardware dependant tasks. The GUI module 140 may rely upon standard techniques to produce graphical components of a user interface, e.g., windows, icons, buttons, menu and the like, for accessing and managing data in networked data sources 125.

BI module 145 includes executable instructions to perform BI-related functions, such as, performing abstract queries and analyses, producing reports, accessing data sources such as relational and/or multidimensional databases, accessing document storage repositories, and the like.

In accordance with the present invention, Visualization module 150 includes executable instructions for creating data visualizations in a display screen and morphing from one visualization to another. With Visualization module 150, users may visualize a data set with multiple visualization types, e.g., charts, tables, and maps, select a region in a visualization to be monitored, and animate a display transformation from one visualization to the next. The selected region is morphed from the one visualization to the next by showing the intermediate changes in the region's shape until it reaches its final shape. The first visualization is faded out of the display screen while morphing is taking place and the second visualization is faded into the display screen when morphing is completed.

Visualization module 150 may also work in conjunction with GUI module 140 to display a GUI to users for creating and displaying visualizations in a display screen. For example, Visualization module 150 may display drop-down menus, textboxes, window widgets, pop-up windows, and other GUI components to enable users to select from different visualization types, highlight or draw attention to regions in a visualization, view information associated with a given visualization, and so on.

It should be appreciated that the executable modules stored in memory 130 are exemplary. It should also be appreciated that the functions of the modules may be combined. For example, GUI module 140 and Visualization module 150 may be integrated into a single module without deviating from the scope and principles of the invention. In addition, the functions of the modules need not be performed on a single machine. Instead, the functions may be distributed across a network, if desired. Indeed, the invention may be commonly implemented in a client-server environment with various components being implemented at the client-side and/or the server-side. As understood by those of ordinary skill in the art, it is the functions of the invention that are significant, not where they are performed or the specific manner in which they are performed.

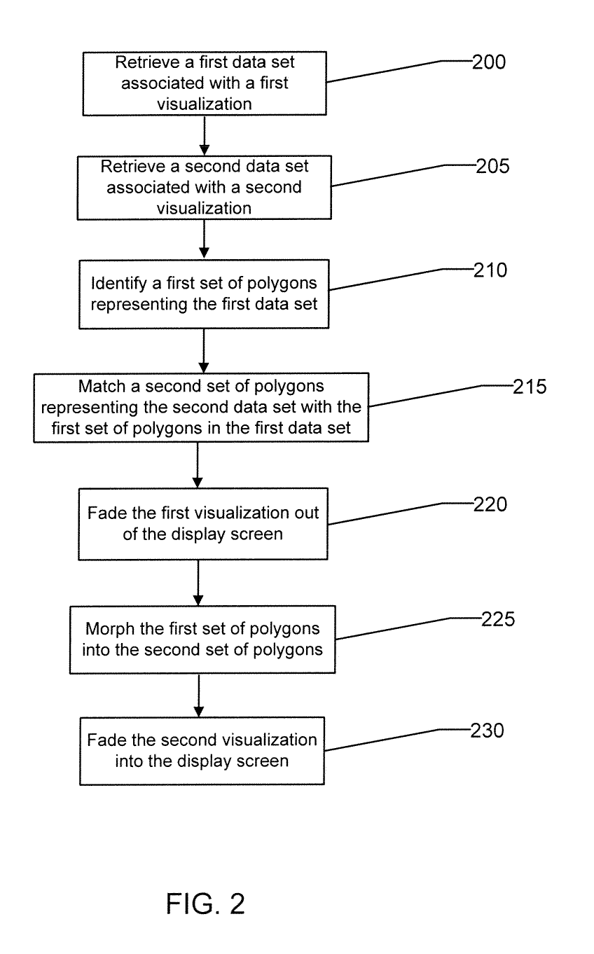

Referring now to FIG. 2, a flow chart for morphing data visualizations in accordance with an embodiment of the invention is described. The operations of FIG. 2 may be implemented using Visualization module 150 either independently or in conjunction with GUI module 140. Initially, Visualization module 150 retrieves a first data set associated with a first visualization (200). The first visualization may be, for example, a visualization of the first data set selected by a user for display in a display screen, such as a chart, table or map representing the first data set on the display screen.

In accordance with an embodiment of the invention, the user may also select a second visualization to be displayed after the first visualization on the display screen. Visualization module 150 then retrieves a second data set associated with the second visualization (205). The second and first data sets may originate from a single common data set or may be different data sets.

For example, the first visualization may be a bar chart of a data set. The second visualization may be a pie chart of the same data set. In another example, the first visualization may be a bar chart of a first data set. The second visualization may also be a bar chart but of a different second data set. The second visualization may also be a pie chart or other visualization of a different second data set.

After retrieving the first and second data sets, Visualization module 150 identifies a first region or a first set of polygons representing the first data set to be morphed (210). The first set of polygons may be selected by a user by, for example, clicking on or highlighting the region. Multiple regions may be selected by, for example, holding the “ctrl” key while clicking the mouse. Visualization module 150 retrieves the data corresponding to the selected region(s) from the first data set to form the first set of polygons to be morphed.

Morphing occurs by first matching a second set of polygons representing the second data set with the first set of polygons representing the first data set (215). The second set of polygons represents a match when it is the same semantic region as the first set of polygons. For example, a bar in a bar chart representing sales data for France is matched with a pie slice in a pie chart also representing sales data for France.

For each candidate starting polygon in the first set of polygons to be morphed, Visualization module 150 finds a point in a destination polygon in the second set of polygons that corresponds to all points in the starting polygon. If there are more points in the starting polygon than the destination polygon, then some, e.g., the nearest, points are regrouped. Conversely, if there are fewer points in the starting polygon than in the destination polygon, some points are split. To avoid incoherent shapes during morphing, the polygons being morphed maintain a convex form. In one embodiment, morphing starts from the top-left corner of the display screen and is applied clockwise. Before morphing is performed, the first visualization is faded out of the display screen (220).

Morphing is performed by animating each stage of the morphing from the first set of polygons into the second set of polygons in the display screen (225). As soon as a match is determined for each point in the starting polygon, each point in the first set of polygons is morphed at a given speed. In one embodiment, the polygons are morphed at logarithmic speed (from the fastest to the slowest). Intermediate polygons are created and displayed at each stage of the morphing, thereby presenting an animation to the user as the morphing occurs. In one embodiment, each intermediate polygon is filled with the same color as its counterpart starting polygon.

The animation performed on the display screen contains a set number of animation frames. The set number of frames is an automatically computed number to obtain a good animation speed. In the embodiment with the logarithmic speed, polygons move faster at the beginning than at the end of the animation because the distance between the initial position and the final one for each animation frame is based on a logarithmic curve: growing fast at the beginning and more slowly as the animation progresses.

When morphing is completed, the second visualization is faded into the display screen (230). In one embodiment, the regions morphed are identified in the second visualization with the same highlighted color used in the first visualization. This way the user is able to easily follow the region from the first visualization to the second visualization and observe what happens with the region during morphing.

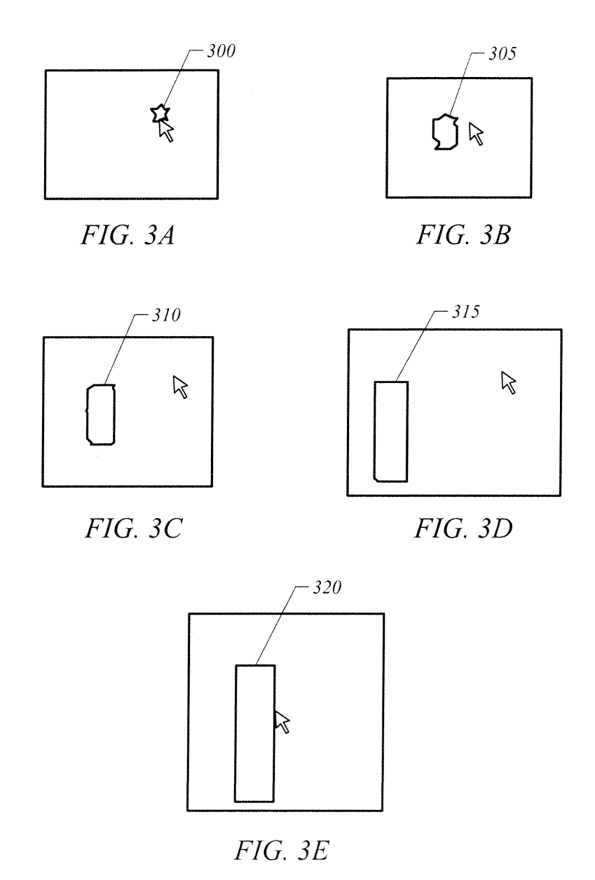

Referring now to FIGS. 3(a)-(e), a series of visualizations showing an exemplary region of a data set being morphed from one visualization to the next in accordance with an embodiment of the invention is described. Region 300 in FIG. 3(a) denotes a region from a first visualization displayed on a display screen. A user highlights the region by, for example, clicking on it with a mouse, to follow what happens to it before a second visualization, such as a bar chart, is displayed on the display screen.

According to an embodiment of the invention, the first visualization is faded out of the display screen and region 300 is morphed into a bar of a second visualization, i.e., a bar chart, before the bar chart is faded into the display screen. FIGS. 3(b)-3(d) show intermediate polygons 305-315 that are displayed at each stage of the morphing on the display screen.

Intermediate polygons 305-315 illustrate to the user what happens to region 300 when a bar chart is displayed on the display screen. Each set of consecutive polygons form a shape closer to the shape of bar 320 in FIG. 3(e) that is shown in the bar chart. When morphing of region 300 is completed and region 320 is displayed, the bar chart is faded into the display screen.

In one embodiment, the highlighting around region 320 is preserved when the bar chart is displayed on the display screen to show the user what happened to region 300 when the bar chart was selected for display. It is appreciated that region 300 and region 320 may be different visualizations of the same data, for example, region 300 and region 320 may both represent revenues for a given geographical region but in different visual formats.

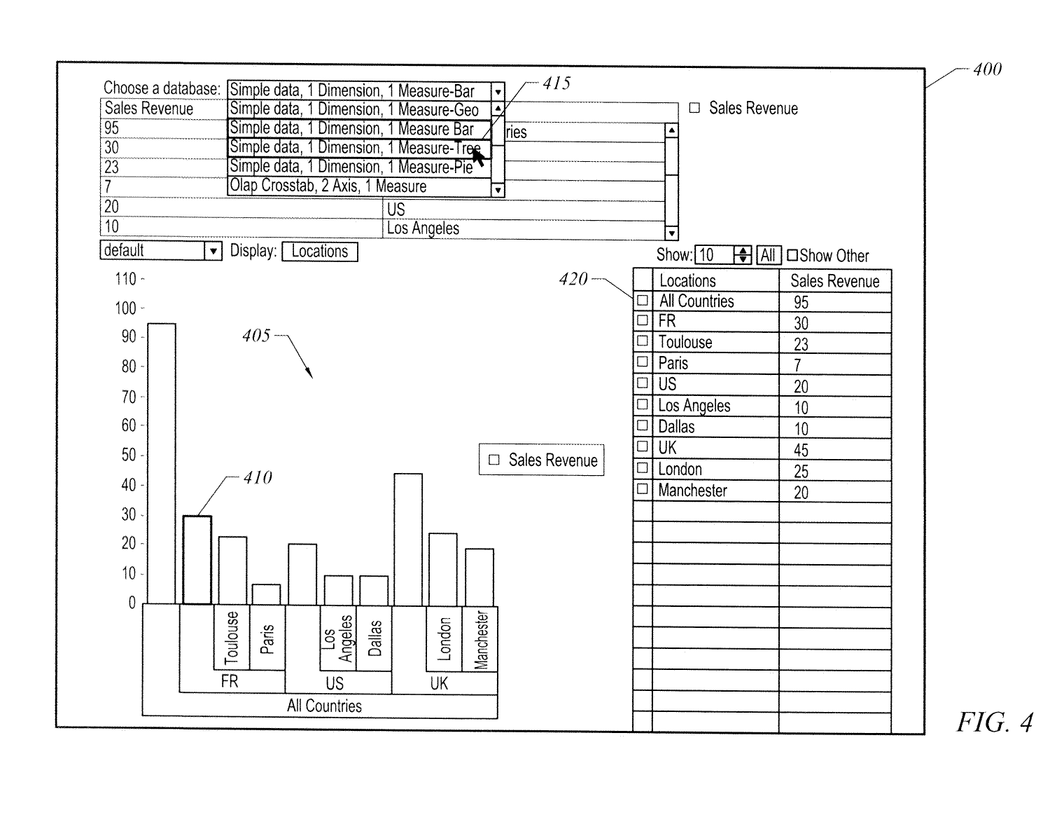

A series of visualizations originating from a common data set is illustrated in FIGS. 4-10. The common data set includes sales revenues for several geographical regions, such as Toulouse and Paris in France, Los Angeles and Dallas in the US, and London and Manchester in the UK. FIG. 4 illustrates an exemplary bar chart showing the sales revenues for those regions in accordance with an embodiment of the invention. Bar chart 405 on display screen 400 shows sales revenues per location, including the regions mentioned and their respective countries. A breakdown of the sales revenues per location is also shown in table form in table 420.

A user viewing bar chart 405 on display screen 400 may desire to focus on the sales revenue for the country of France. For example, the user may be performing an analysis of the sales performance in France as compared to the other regions. In doing so, the user may want to visualize the data set including the sales revenues in France in multiple visualization types. To start its analysis, the user clicks on or highlights bar 410 in bar chart 405 representing the sales revenues in France. The user then selects a tree chart in drop-down menu 420 to be displayed on display screen 400 after bar chart 405.

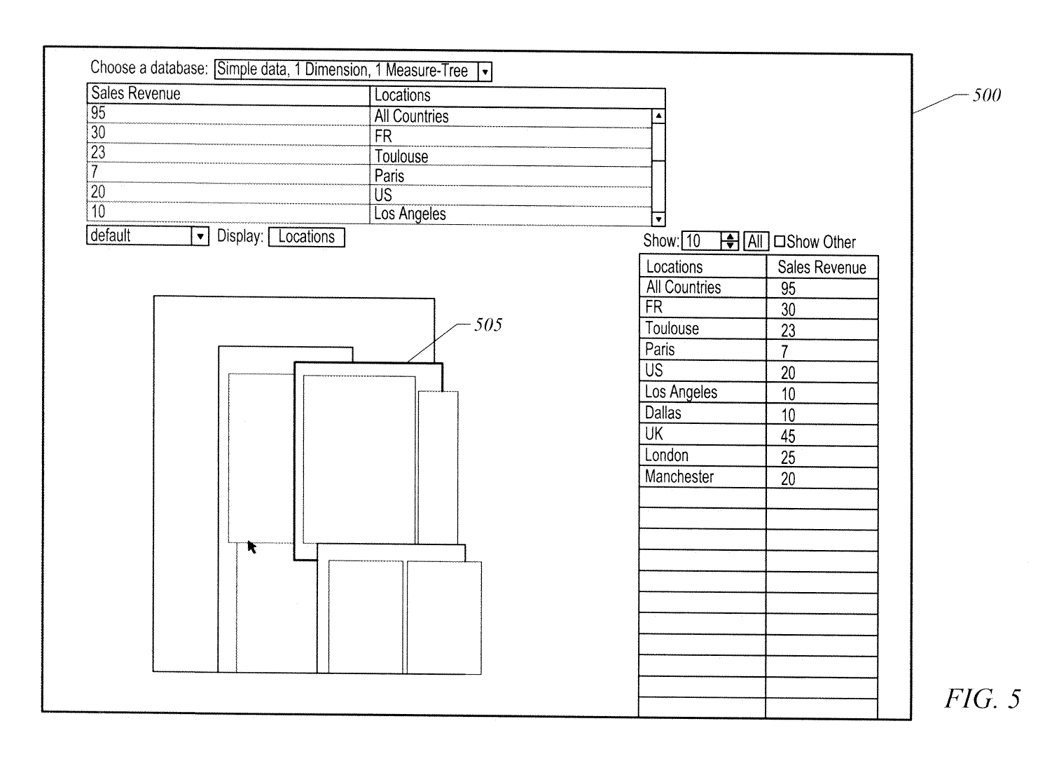

According to an embodiment of the invention, bar chart 405 is faded out of display screen 400 so that a tree chart as selected by the user can be displayed on the screen. Bar 410 selected by the user is then morphed until it reaches its final shape in a tree chart. FIG. 5 illustrates the intermediate visualizations produced when morphing region 410. As shown on display screen 500, region 410 is morphed into a set of intermediate polygons 505.

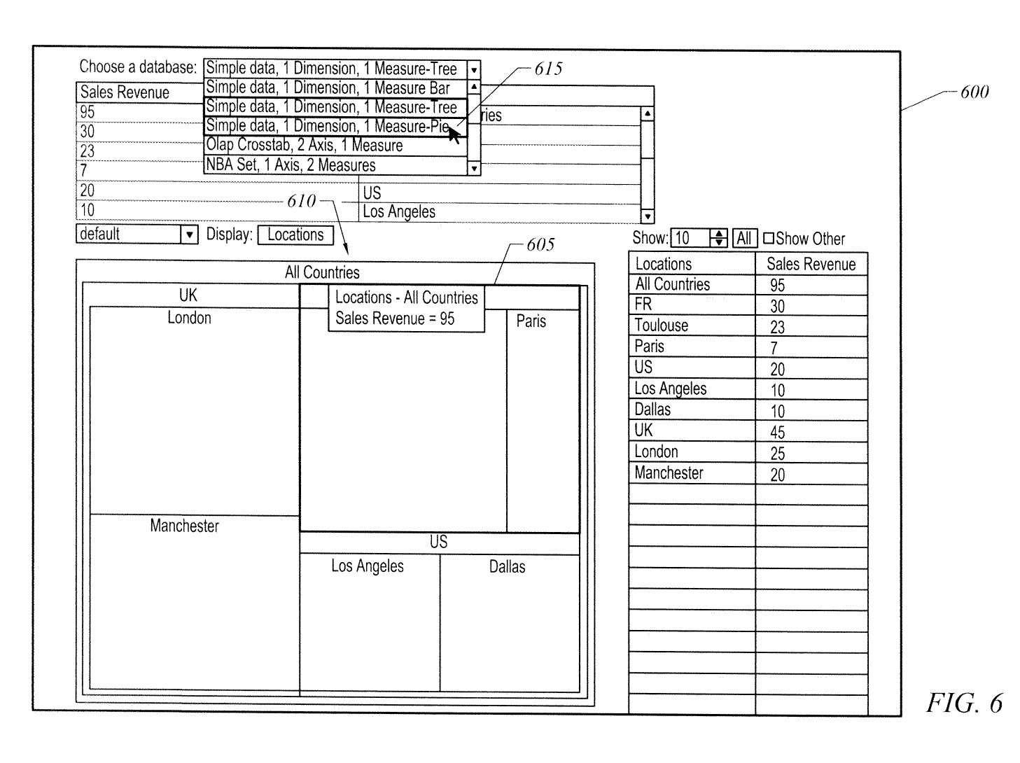

FIG. 6 illustrates an exemplary tree chart generated after the morphing of region 410 is completed. Display screen 600 shows that region 410 has been morphed into region 605 of tree chart 610. Region 605 is the final shape assumed by region 410 when morphing is completed. Note that region 505 in FIG. 5 is a set of intermediate polygons that has a shape close to region 605. At each stage of the morphing, the set of intermediate polygons forms a shape closer to the shape of the new visualization. The new visualization is faded into the display screen after all the morphing is performed and the set of intermediate polygons is displayed.

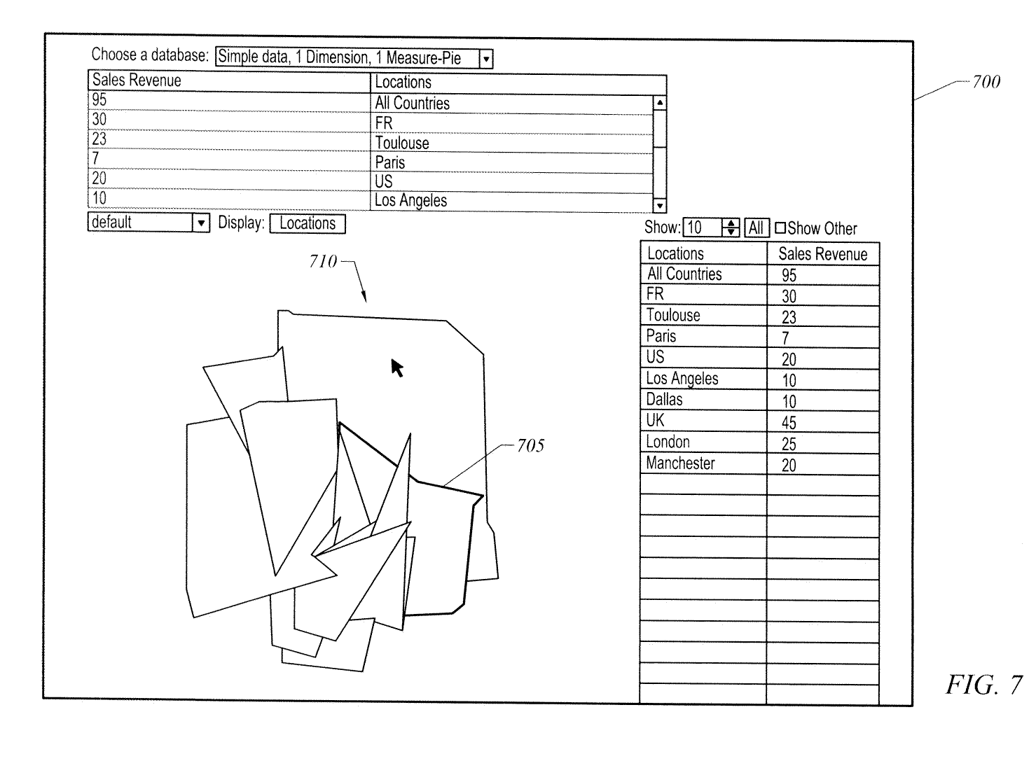

A similar morphing process is repeated when the user desires to change the visualization from tree chart 610 into another visualization type selected in drop-down menu 615, such as a pie chart. Tree chart 610 is faded out of the display screen and region 605 is morphed into a pie slice. FIG. 7 illustrates the intermediate visualizations produced when morphing region 605. Region 605 is morphed into a series of intermediate polygons such as set of intermediate polygons 705 in intermediate visualization 710 shown on display screen 700.

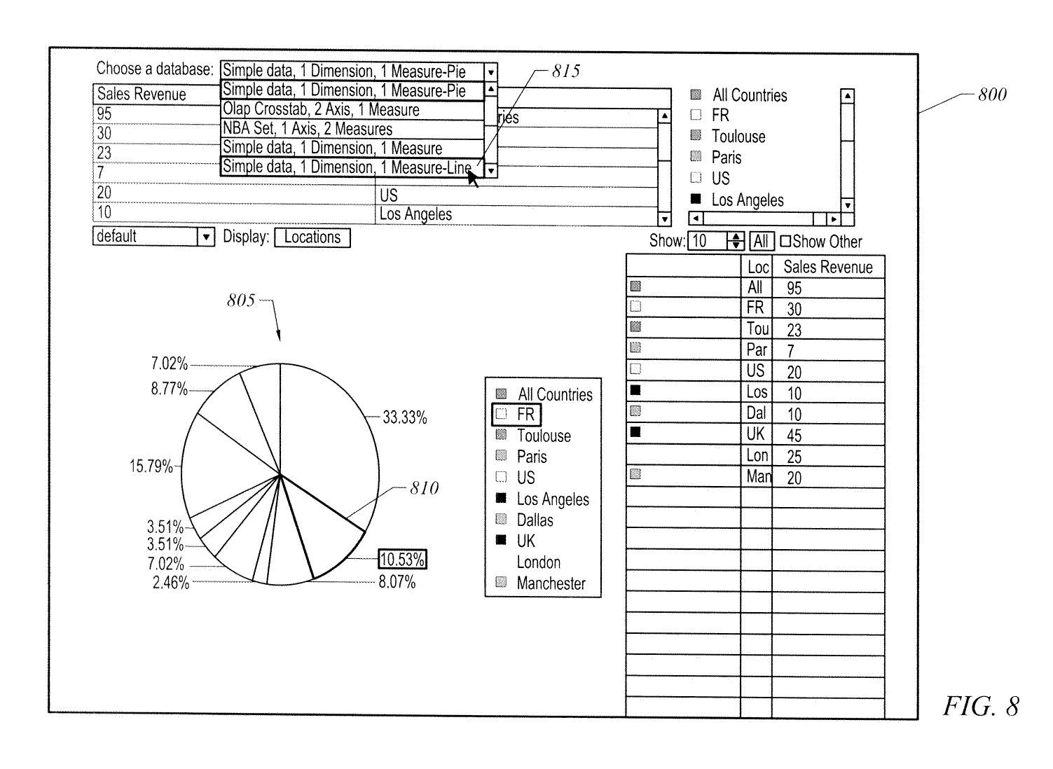

The pie chart generated is illustrated in FIG. 8. Pie chart 805 is faded into display screen 800 after morphing of region 605 is completed. Region 605 is morphed into pie slice 810, which is highlighted in pie chart 805 to illustrate to the user the changes that take place when the data illustrated in region 605 in tree chart 610 is represented as pie slice 810 in pie chart 805.

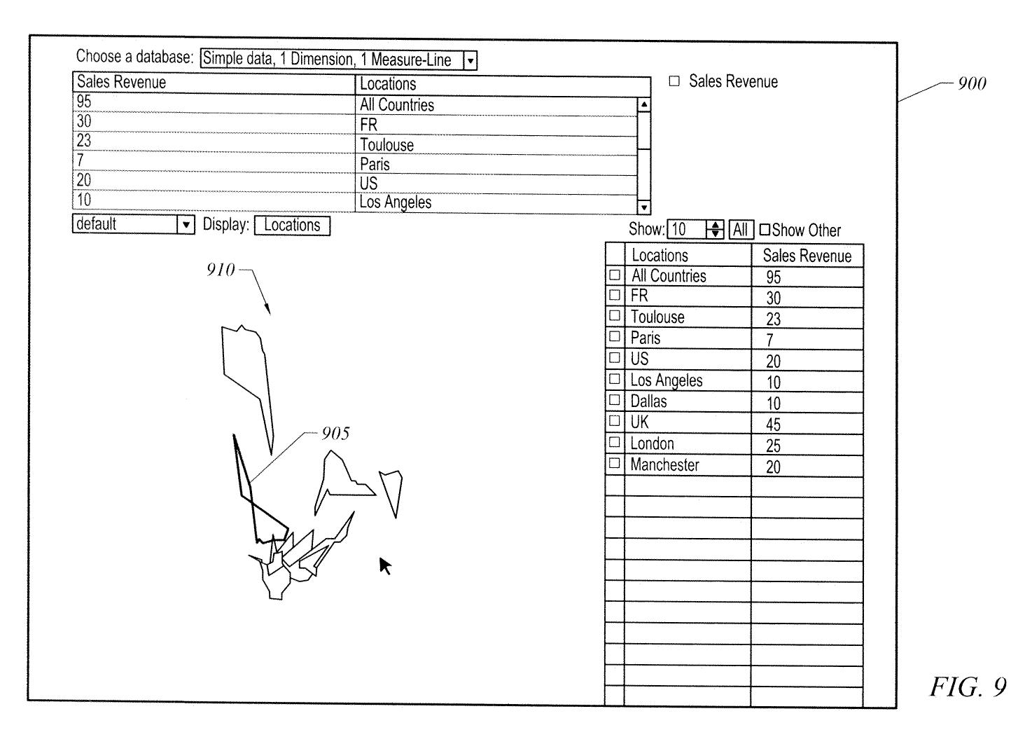

Another visualization of the same data set can be selected by the user in drop-down menu 815, such as a line chart. Pie chart 805 is faded out of display screen 800 and pie slice 810 is morphed into a section of a line chart. FIG. 9 illustrates the intermediate visualizations produced when morphing region 810. Region 810 is morphed into a series of intermediate polygons such as set of intermediate polygons 905 in intermediate visualization 910 shown on display screen 900.

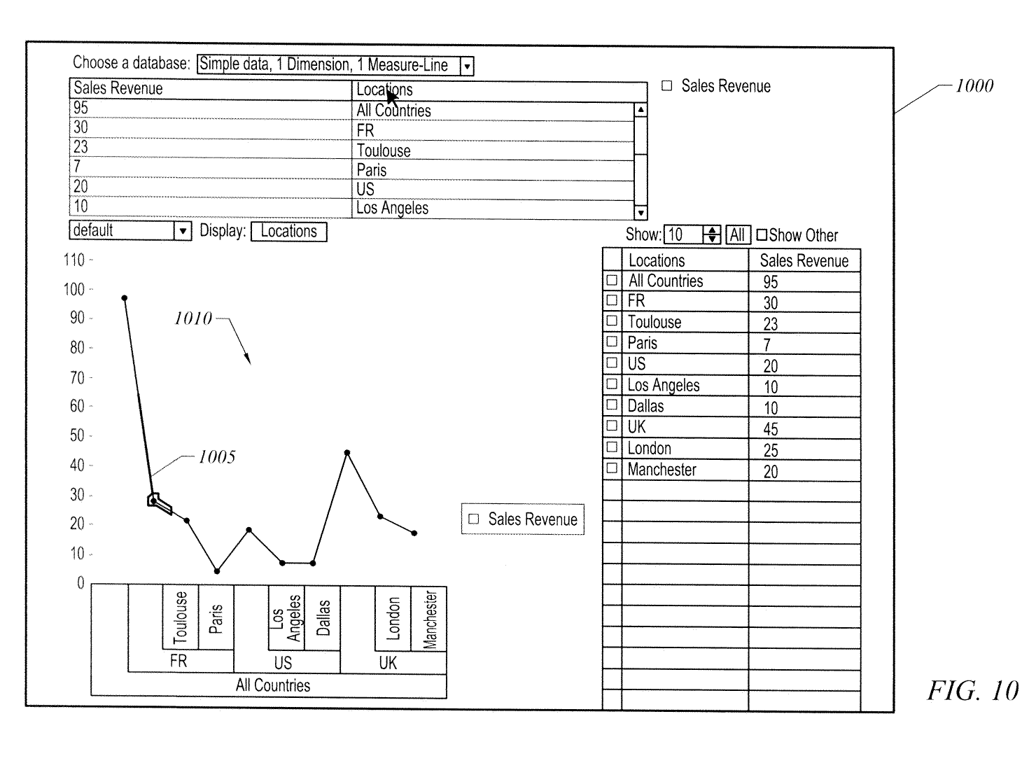

The line chart generated is illustrated in FIG. 10. Line chart 1005 is faded into display screen 1000 after morphing of region 810 is completed. Region 810 is morphed into line section 1005, which is highlighted in line chart 1010 to illustrate to the user the changes that take place when the data illustrated in region 810 in pie chart 805 is represented as line section 1005 in line chart 1010.

Display screens 400, 500, 600, 700, 800, 900, and 1000 shown on FIGS. 4-10, respectively, includes GUI components such as drop-down menus, textboxes, and the like. Display screen 400 may also include multiple visualizations at a time, such as a table and a pictorial representation of data. It is appreciated that the GUI components shown on display screens 400-1000 in FIGS. 4-10 are shown for illustration purposes only. Additional GUI components and features may be used without deviating from the scope and purposes of the invention.

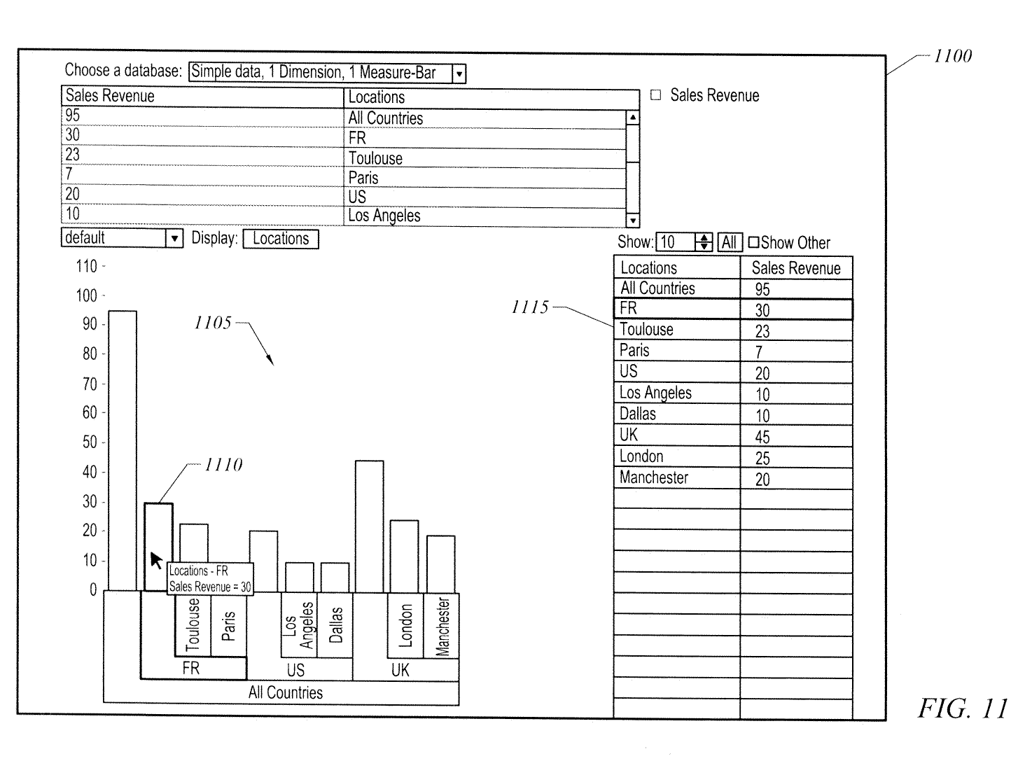

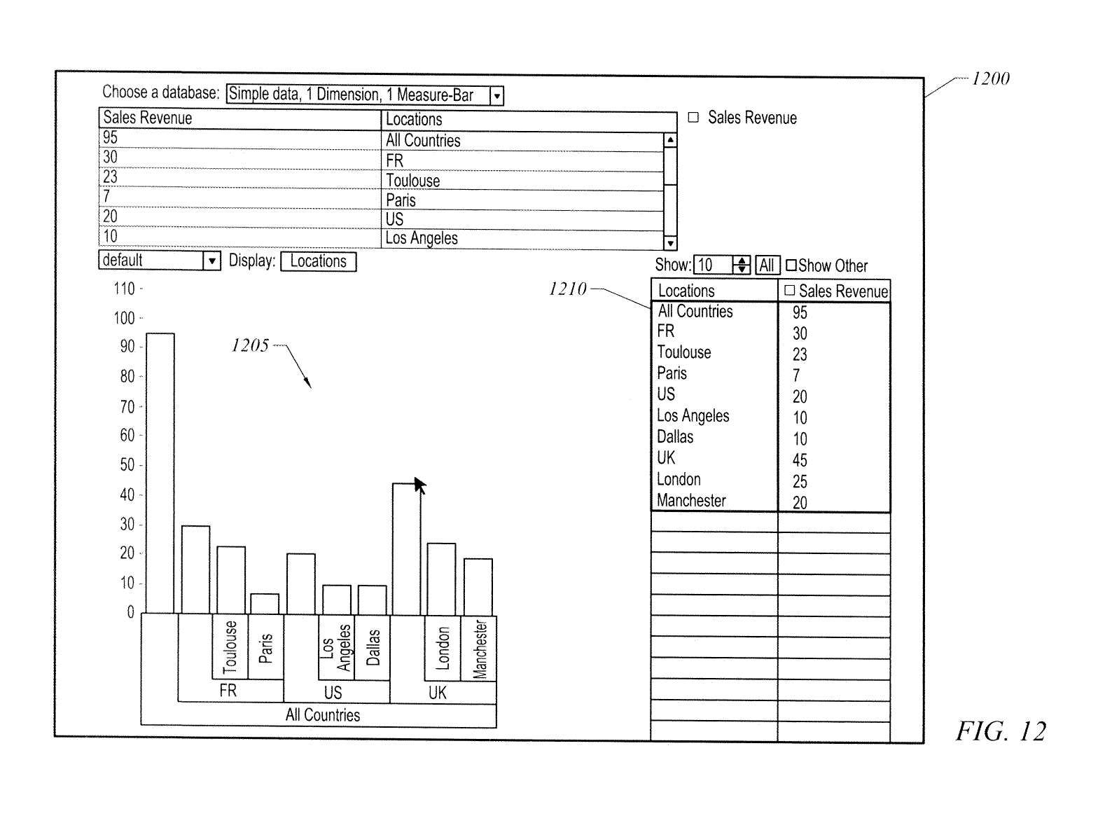

For example, FIGS. 11-12 illustrate how the user may select a region to be morphed in a visualization. Bar chart 1105 on display screen 1100 shows bar 1110 representing the sales revenues for the country of France. Instead of highlighting bar 1110 (such as highlighted bar 410 illustrated in FIG. 4), Visualization module 150 may identify regions to be morphed in a visualization by emphasizing the color in the region and diluting the color of non-selected regions in the same visualization. Emphasis may also be added to illustrate the sales revenue data in table 1115. As shown in FIG. 11, region 1110 has its color (e.g., shade) emphasized while the other regions in bar chart 1105 have their color diluted and are not as noticeable on display screen 1100.

When all regions are emphasized by the user, the entire visualization is displayed as the same color. For example, bar chart 1205 in FIG. 12 is shown with all the bars having the same shade and emphasis. Table 1210 is also displayed with all its rows highlighted. In this case, the user may desire to morph all regions in bar chart 1205 to follow what happens to the regions when another visualization is selected. It is appreciated that the user may select as many regions as desired for morphing.

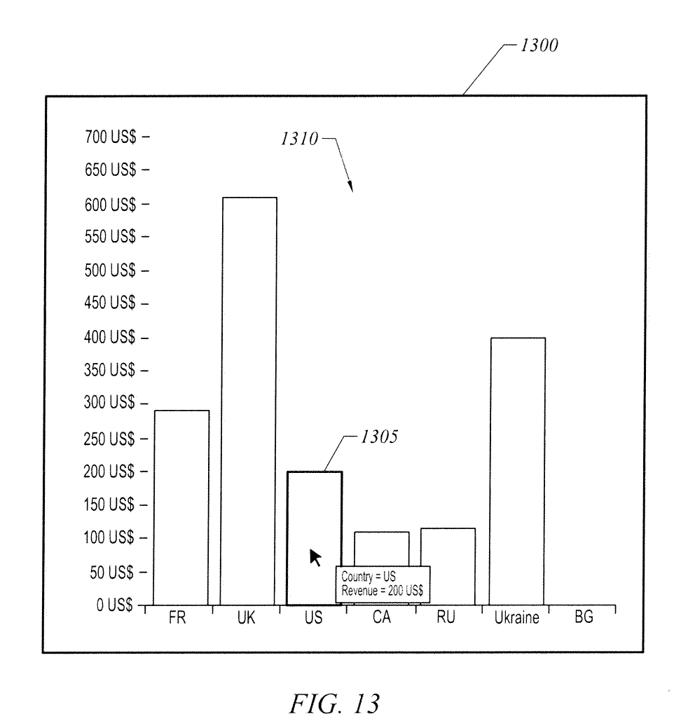

According to an embodiment of the invention, morphing may also be performed to illustrate what happens between visualizations of the same type that represent different data sets, e.g., morphing between a bar chart and another bar chart containing an additional data set represented in an additional bar. For example, FIG. 13 illustrates bar chart 1310 on display screen 1300 representing a data set that contains “FR,” “UK,” “US,” “CA,” RU,” “Ukraine,” and “BG.” Bar 1305 is emphasized by the user as a new bar chart representing a data set selected for display.

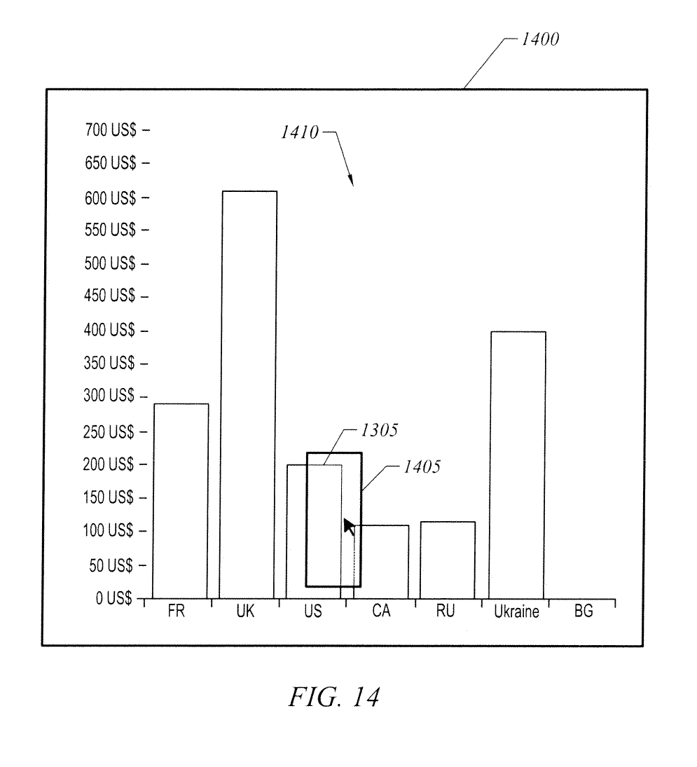

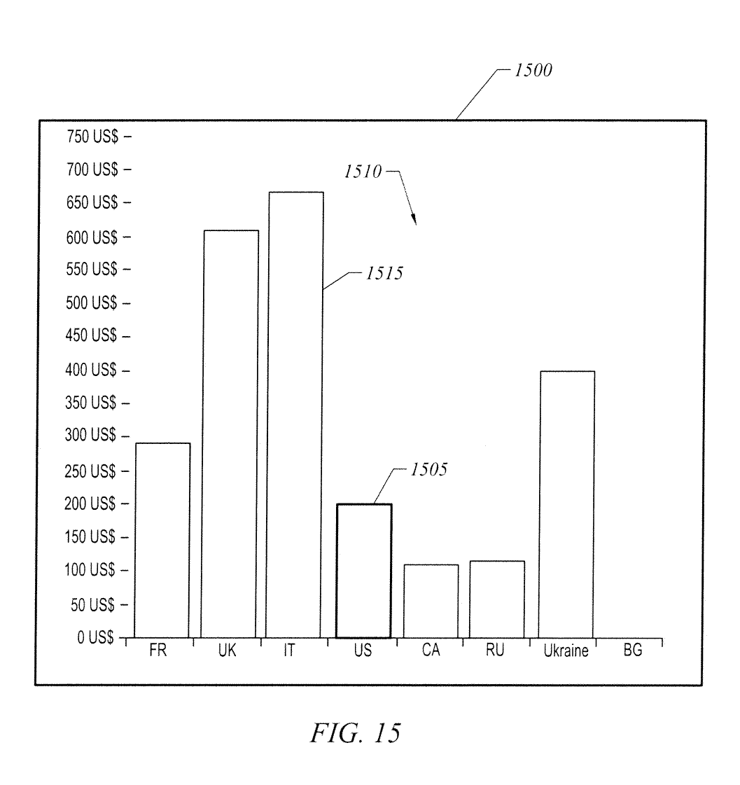

FIG. 14 illustrates the intermediate polygons generated when morphing bar 1305. As shown on display screen 1400, bar chart 1310 is faded out and bar 1305 is morphed into bar 1405 until it reaches its final shape in the new bar chart. The new bar chart is illustrated in FIG. 15 as bar chart 1510. Bar chart 1510 represents a data set that adds data for “IT,” displayed as bar 1515 on display screen 1500.

Note that bar 1505 is the result of morphing bar 1305 shown on bar chart 1310 in FIG. 13. When morphing is completed, bar chart 1510 is faded into display screen 1500. In this case, since the first and second visualizations are of the same type, e.g., bar charts 1310 and bar chart 1510, the morphing performed on bar 1305 is simply a change in position of bar 1305 in the new chart. This is noticeable in FIG. 14, where bar 1305 is morphed into intermediate bar 1405. Intermediate bar 1405 has the same shape and color as bar 1305 but is being moved into a different position of the new bar chart, i.e., it is being moved into bar 1505 in bar chart 1510.

It is appreciated that morphing between visualizations of the same type representing different data sets, e.g., morphing between a bar chart and another bar chart containing an additional data set represented in an additional bar, may be performed on the whole visualization. For example, in the case where the second visualization has an additional data set, morphing may be performed by moving all components in the first visualization, e.g., all bars of a bar chart, into their new positions in the second visualization to accommodate the additional data set. In the example above shown in FIGS. 13-15, bar chart 1310 would be morphed into bar chart 1510 in FIG. 15 by morphing all the bars in bar chart 1310 (and not just bar 1305 selected by the user) into their new positions in bar chart 1510 to accommodate the additional data set for “IT” represented in bar 1515.

According to an embodiment of the invention, if the user desires to change from one visualization type to the same visualization type for a data set that has more or less data, morphing may be performed by preserving the characteristics of the data present in both data sets. For example, a pie chart representing a data set that contains “FR,” “UK,” “US,” “CA,” “RU,” “Ukraine,” and “BG” may be morphed into a pie chart representing a data set that contains all the countries listed in addition to “IT.” In this case, Visualization module 150 may preserve the color on the regions present in both visualizations.

Advantageously, the invention enables users to follow what happens to data, i.e., how it has been transformed, between visualizations. Users may focus on selected portions of a data set to seamlessly understand how the selected data is transformed between visualizations.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications. they thereby enable others skilled in the art to best utilize the invention and various embodiments with various modifications as are suited to the particular use contemplated. It is intended that the following claims and their equivalents define the scope of the invention.

What is claimed is:

1. A computer readable storage medium, comprising executable instructions to:
display a first visualization associated with a first set of data; and
animate a display transformation from the first visualization into a second visualization by morphing selected polygons in the first visualization into corresponding polygons in the second visualization while fading the first visualization into the second visualization.

2. The computer readable storage medium of claim 1, wherein the first visualization and the second visualization are selected from the list comprising: line chart; bar chart; pie chart; bubble chart; scatter plot; geographical visualization; and tree visualization.

3. The computer readable storage medium of claim 1, wherein the executable instructions to animate a display transformation comprise executable instructions to display intermediate polygons while morphing selected polygons in the first visualization into corresponding polygons in the second visualization.

4. The computer readable storage medium of claim 3, wherein the executable instructions to animate a display transformation comprise executable instructions to morph selected polygons in the first visualization into corresponding polygons in the second visualization at logarithmic speed.

5. The computer readable storage medium of claim 4, wherein the executable instructions to animate a display transformation further comprise executable instructions to identify a first set of polygons representing the first set of data and to match the first set of polygons with a second set of polygons representing a second set of data associated with the second visualization.

6. The computer readable storage medium of claim 5, wherein the executable instructions to match the first set of polygons with the second set of polygons comprise executable instructions to identify a point in a destination polygon in the second set of polygons that corresponds to two or more points of a starting polygon in the first set of polygons.

7. The computer readable storage medium of claim 5, wherein the executable instructions to match the first set of polygons with the second set of polygons comprises executable instructions to identify a point in a starting polygon in the first set of polygons that corresponds to two or more points of a destination polygon in the second set of polygons.

8. The computer readable storage medium of claim 6, wherein the executable instructions to identify a point in a destination polygon in the second set of polygons that corresponds to two or more points of a starting polygon in the first set of polygons comprise executable instructions to regroup points if the starting polygon has more points than the destination polygon.

9. The computer readable storage medium of claim 7, wherein the executable instructions to identify a point in a starting polygon in the first set of polygons that corresponds to two or more points of a destination polygon in the second set of polygons comprise executable instructions to split points if the starting polygon has fewer points than the destination polygon.

10. The computer readable storage medium of claim 3, further comprising executable instructions to fill the intermediate polygons with a color used to display the selected polygons in the first visualization.

11. The computer readable storage medium of claim 1, wherein the executable instructions to animate a display transformation from the first visualization into the second visualization comprise executable instructions to fade out the first visualization and fade in the second visualization.

12. A computer readable storage medium, comprising executable instructions to:
retrieve a first set of data associated with a first visualization and a second set of data associated with a second visualization, the first visualization displayed on a display screen and the second visualization selected by a user for display on the display screen after the first visualization;
identify a first set of polygons representing the first set of data;
match a second set of polygons representing the second set of data with the first set of polygons representing the first set of data;
fade the first visualization out of the display screen;
morph the first set of polygons into the second set of polygons; and
fade the second visualization into the display screen.

13. The computer readable storage medium of claim 12, wherein the first visualization and the second visualization are selected from the list comprising: line chart; bar chart; pie chart; bubble chart; scatter plot; geographical visualization; and tree visualization.

14. The computer readable storage medium of claim 12, wherein the first set of data and the second set of data originate from a common data set.

15. The computer readable storage medium of claim 12, wherein the first visualization and the second visualization are of the same type.

16. The computer readable storage medium of claim 12, wherein the executable instructions to identify a first set of polygons representing the first set of data comprise executable instructions to identify the first set of polygons in response to a user selection of an area in the first visualization corresponding to the first set of polygons.

17. The computer readable storage medium of claim 12, wherein the executable instructions to match a second set of polygons representing the second set of data with the first set of polygons representing the first set of data comprise executable instructions to match points in a destination polygon in the second set of polygons to points in a starting polygon in the first set of polygons.

18. The computer readable storage medium of claim 17, further comprising executable instructions to associate a logarithmic speed with each point in the starting polygon.

19. The computer readable storage medium of claim 18, wherein the executable instructions to morph the first set of polygons into the second set of polygons comprise executable instructions to display intermediate polygons in the display screen while morphing the first set of polygons into the second set of polygons.

20. A method for morphing a first visualization into a second visualization, comprising:
identifying a first set of polygons representing a first set of data corresponding to a first visualization;
identifying a second set of polygons representing a second set of data corresponding to a second visualization;
matching points in the first set of polygons with points in the second set of polygons;
fading out the first visualization;
displaying a set of intermediate polygons while morphing the points in the first set of polygons into matching points in the second set of polygons; and
fading in the second visualization.

21. The method of claim 20, wherein identifying a first set of polygons representing a first set of data corresponding to the first visualization comprises identifying the first set of polygons in response to a user selection of an area in the first visualization corresponding to the first set of polygons.

22. The method of claim 20, wherein identifying a second set of polygons representing a second set of data corresponding to the second visualization comprises identifying a semantic zone in the second set of data corresponding to the first set of polygons representing the first set of data.

23. The method of claim 20, wherein matching points in the first set of polygons with points in the second set of polygons comprises identifying a point in a destination polygon in the second set of polygons that corresponds to two or more points of a starting polygon in the first set of polygons.

24. The method of claim 20, wherein matching points in the first set of polygons with points in the second set of polygons comprises identifying a point in a starting polygon in the first set of polygons that corresponds to two or more points of a destination polygon in the second set of polygons.

24. The method of claim 20, further comprising maintaining a color used for the first set of polygons when displaying the intermediate set of polygons in the display screen.

25. The method of claim 20, further comprising displaying the second set of polygons in the display screen upon completion of morphing the points in the first set of polygons into matching points in the second set of polygons.
